(19) United States
(12) Patent Application Publication
(10) Pub. No.: US 2021/0110646 A1
(43) Pub. Date: Apr. 15, 2021

(54) SYSTEMS AND METHODS OF GEOLOCATING AUGMENTED REALITY CONSOLES

(71) Applicant: Citrix Systems, Inc., Fort Lauderdale, FL (US)

(72) Inventors: Pawan Kumar Dixit, Bangalore (IN); Tejus M. Adiga, Bangalore (IN); Anudeep Narasimhaprasad Athlur, Banglore (IN)

(73) Assignee: Citrix Systems, Inc., Fort Lauderdale, FL (US)

(21) Appl. No.: 16/599,638

(22) Filed: Oct. 11, 2019

(51) Int. Cl. G07F 17/32; G06T 19/00; G06F 3/01; G02B 27/01; G06K 9/00

(52) U.S. Cl. CPC G07F 17/3225; G06T 19/006; G07F 17/3204; G02B 27/017; G06K 9/00671; G06F 3/011

(57) ABSTRACT

A computer system is provided. The computer system includes a memory, a network interface, a user interface, and at least one processor. The at least one processor is configured to detect a location identifier via the network interface; identify map data associated with the location identifier, the map data being descriptive of a physical environment; identify at least one target location in the map data, the at least one target location being associated with an augmented reality (AR) console including one or more user interface controls, the at least one target location identifying at least one target position within the physical environment; and overlay the at least one target position, as presented via the user interface, with the AR console.

### BACKGROUND

Computer manufacturers offer a variety of computing devices to meet the needs of users. For instance, a desktop computer system that includes a monitor, mouse, and keyboard can be configured to meet the needs of many office employees. However, employees with more specialized work requirements may need more specialized equipment. For example, users who concurrently consider multiple, discrete portions of information, such as drawings and word processing documents concerning the drawings, benefit from having concurrent visual access to the discrete portions of information. This concurrent visual access can be provided by a desktop computer system that includes multiple monitors. In another example, a user who travels frequently can benefit from a mobile computing device and/or multiple stationary computing devices that reside at locations visited by the user.

### SUMMARY

In at least one example, a computer system is provided. The computer system includes a memory, a network interface, a user interface, and at least one processor coupled to the memory, the network interface, and the user interface. The at least one processor is configured to detect a location identifier via the network interface; identify map data associated with the location identifier, the map data being descriptive of a physical environment; identify at least one target location in the map data, the at least one target location being associated with an augmented reality (AR) console including one or more user interface controls, the at least one target location identifying at least one target position within the physical environment; and overlay the at least one target position, as presented via the user interface, with the AR console.

At least some examples of the computer system can include one or more of the following features. In the computer system, the location identifier can be one or more of a set of global positioning system coordinates, a network service set identifier, and a location beacon identifier. In the computer system, to detect the location identifier can include to detect one or more location beacons. In the computer system, to detect the one or more location beacons can include to detect at least three location beacons and to detect the location identifier comprises to triangulate a location from the at least three location beacons.

The computer system can further include the remote AR console service. In the computer system, to identify the map data can include to transmit the location identifier to a remote AR console service and to receive the map data from the remote AR console service. In the computer system, to identify the map data can include to determine that no previously generated map data descriptive of the physical environment is accessible and to execute a simultaneous localization and mapping process to generate the map data. In the computer system, the at least one processor can be further configured to upload the map data to a remote AR console service.

In the computer system, the at least one processor can be further configured to identify an anchor point having a target location in the map data, the target location identifying a target position within the physical environment, and overlay the target position, as presented via the user interface, with the anchor point. In the computer system, to identify the at least one target location can include to receive a selection of the anchor point, identify the one or more user interface controls as being associated with the anchor point, and identify the at least one target location as being associated with the one or more user interface controls. In the computer system, the one or more user interface controls can include two or more virtual monitor controls.

In the computer system, the at least one processor can be further configured to receive input via the AR console, transmit the input to a virtual resource, receive output from the virtual resource, and render the output within the AR console. In the computer system, the location identifier can be a first location identifier, the map data can be first map data, the physical environment can be a first physical environment, the at least one target location can be at least one first target location, the AR console can be a first AR console, and the target position can be a first target position. Further, in the computer system, the at least one processor can be further configured to detect a second location identifier via the network interface; identify second map data associated with the second location identifier, the second map data being descriptive of a second physical environment; identify at least one second target location in the second map data associated with a second AR console, the at least one second target location identifying at least one second target position within the second physical environment; and overlay the at least one second target position, as presented via the user interface, with the second AR console.

In another example, a method of providing at least one augmented reality (AR) console using a computer system is provided. The computer system includes a network interface and a user interface. The method includes acts of detecting a location identifier via the network interface; identifying map data associated with the location identifier, the map data being descriptive of a physical environment; identifying at least one target location in the map data, the at least one target location being associated with an AR console including one or more user interface controls, the at least one target location identifying at least one target position within the physical environment; and overlaying the at least one target position, as presented via the user interface, with the AR console.

At least some examples of the method can include one or more of the following features. In the method, the act of detecting the location identifier can include an act of detecting one or more location beacons. The act of detecting the one or more location beacons can include an act of detecting at least three location beacons and detecting the location identifier comprises triangulating a location from the at least three location beacons. The act of identifying the map data can include acts of determining that no previously generated map data descriptive of the physical environment is accessible and executing a simultaneous localization and mapping process to generate the map data.

The method can further include an act of uploading the map data to a remote AR console service. The method can further include acts of identifying an anchor point having a target location in the map data and overlaying the target location, as presented via the user interface, with the anchor point. In the method, the act of identifying the at least one target location can include acts of receiving a selection of the anchor point, identifying the one or more user interface controls as being associated with the anchor point, and identifying the at least one target location as being associated with the one or more user interface controls. The act of identifying the at least one target location can include an act of identifying two or more target locations associated with two or more virtual monitor controls.

The method can further include acts of receiving input via the AR console, transmitting the input to a virtual resource, receiving output from the virtual resource, and rendering the output within the AR console. In the method, the location identifier can be a first location identifier, the map data can be first map data, the physical environment can be a first physical environment, the at least one target location can be at least one first target location, the AR console can be a first AR console, and the target position can be a first target position. The method can further include acts of detecting a second location identifier via the network interface; identifying second map data associated with the second location identifier, the second map data being descriptive of a second physical environment; identifying at least one second target location in the second map data associated with a second AR console, the at least one second target location identifying at least one second target position within the second physical environment; and overlaying the at least one second target position, as presented via the user interface, with the second AR console.

In another example, a non-transitory computer readable medium is provided. The computer readable medium stores processor executable instructions to provide at least one augmented reality (AR) console. The instructions include instructions to detect a location identifier via a network interface; identify map data associated with the location identifier, the map data being descriptive of a physical environment; identify at least one target location in the map data, the at least one target location being associated with an AR console including one or more user interface controls, the at least one target location identifying at least one target position within the physical environment; and overlay the at least one target position, as presented via the user interface, with the AR console.

At least some examples of the computer readable medium can include one or more of the following features. In the computer readable medium, the instructions to identify the map data can include instructions to determine that no previously generated map data descriptive of the physical environment is accessible and execute a simultaneous localization and mapping process to generate the map data. The computer readable medium can further include instructions to identify an anchor point having a target location in the map data; and overlay the target location, as presented via the user interface, with the anchor point. The instructions to identify the at least one target location can include instructions to receive a selection of the anchor point, identify the one or more user interface controls as being associated with the anchor point, and identify the at least one target location as being associated with the one or more user interface controls. The instructions to identify the at least one target location can include instructions to identify two or more target locations associated with two or more virtual monitor controls. The instructions can further include instructions to receive input via the AR console; transmit the input to a virtual resource; receive output from the virtual resource; and render the output within the AR console.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of an augmented reality (AR) console system in accordance with an example of the present disclosure.

FIGS. 2 and 3 are a flow diagram of an AR process in accordance with an example of the present disclosure.

FIG. 4 is a block diagram of a network environment of computing devices in which various aspects of the present disclosure can be implemented.

FIG. 5 is a block diagram of the AR console system of FIG. 1 as implemented by a configuration of computing devices in accordance with an example of the present disclosure.

FIG. 6 is an illustration of the AR console system of FIG. 1 while in use in accordance with an example of the present disclosure.

### DETAILED DESCRIPTION

As summarized above, various examples described herein are directed to AR console systems and methods. These systems and methods overcome technical difficulties that arise when users require a variety of physical computing devices to meet their needs. For example, a user who is a manager or a sales engineer may benefit from a variety of physical computing device configurations during any given workday. At some points in the workday, either of these users may benefit from a multi-monitor desktop setup that concurrently provides several sources of information to the user. At other points in the workday, either of these users may benefit from a large monitor or projector that displays presentation content and/or product demonstrations to a group of employees or potential customers. At still other points in the workday, either of these users may benefit from a laptop or some other mobile computing device that allows them to work at a customer site. Provision, maintenance, and replacement (e.g., due to obsolescence) of the sundry computing devices described above is costly and burdensome for both users of the computing devices and information technology staff tasked with maintaining their performance and integrity. Moreover, the sundry computing devices consume both power and physical space, adding to their cost and inconvenience.

To address these and other issues, AR console systems and methods are provided. These systems and methods enable a user of an AR headset, such as the manager or sales engineer, to spawn different applications and desktops and to overlay physical objects at various geolocations with the applications and desktops. Further, the AR consoled systems and methods described herein provide for storage and restoration of the applications and desktops at target physical geolocations. In so doing, the systems and methods described herein provide users with continuity, enabling the user to revisit the geolocations and continue working on the applications and desktops as if the applications and desktops are physically installed at the geolocations.

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

### AR Console System

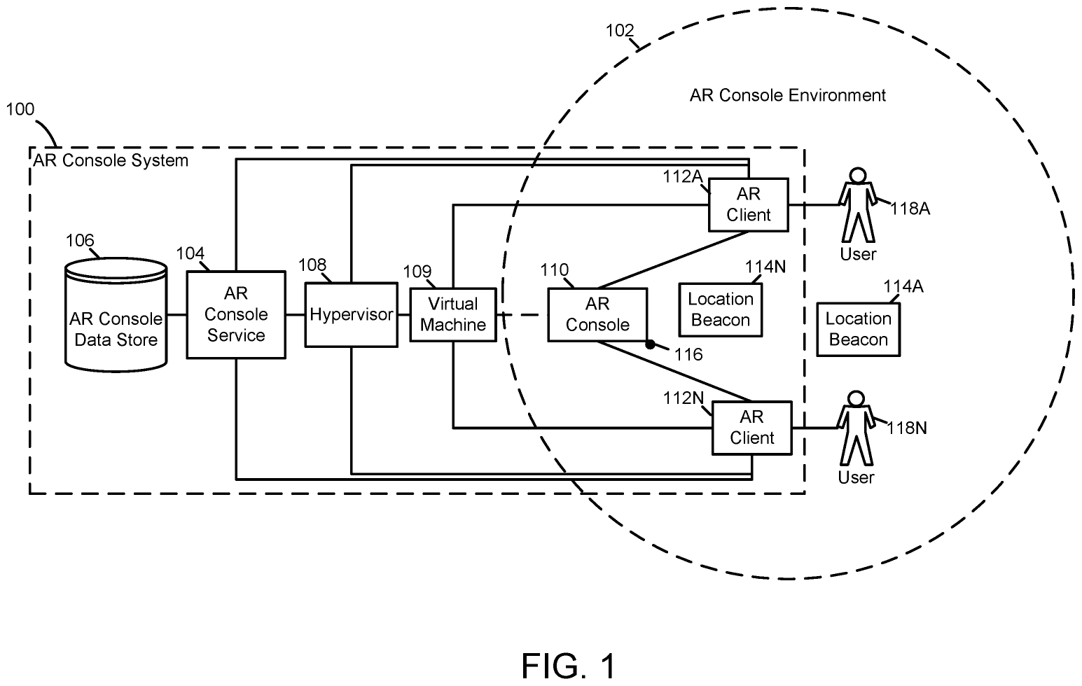

In some examples, an AR console system is configured to implement AR consoles with particular configurations at specific geographic locations. FIG. 1 illustrates a logical architecture of an AR console system 100 in accordance with these examples. As shown, the system 100 includes an AR console service 104, an AR console data store 106, a hypervisor 108, a virtual machine 109, an AR console 110, an anchor point 116, and AR clients 112A-112N. The AR console environment 102 can include, for example, an indoor area, such as one or more rooms within a building. The AR console system 100 is configured to render the anchor point 116 and the AR console 110 within the AR console environment 102. As shown in FIG. 1, the AR console environment 102 includes the AR clients 112A-112N, location beacons 114A-114N, and users 118A-118N. For ease of reference, each of the clients 112A-112N, the beacons 114A-114N, and the users 118A-118N may be referred to collectively as the clients 112, beacons 114, and users 118. Individual members of these collectives may be referred to generically as the client 112, the beacon 114, and the user 118.

In some examples, each of the clients 112 is configured to provide an interface to each of the users 118 that enables user interaction with one or more AR consoles, such as the AR console 110. The AR consoles are input and/or output interfaces between the user 118 and the computing resources included within the system 100. In some examples, the AR consoles include user interface controls that represent physical input and/or output devices (e.g., a keyboard, a mouse, a touchscreen, one or more monitors, etc.) within a mixed or augmented reality environment. In these examples, the user interface controls are rendered, using an AR platform such as GOOGLE ARCore and/or APPLE ARKit, within a context made up of the actual physical objects present in the AR console environment 102. This context can include images of the AR console environment 102 acquired from the point of view of the user 118. Alternatively or additionally, the user interface can support controls that are not rendered visually. In these examples, each of the clients 112 is configured to receive input selecting or otherwise manipulating invisible controls via vocal intonations or gestures articulated by the user. By rendering this variety of user interface controls to the user 118 within the context of the AR console environment 102, the system 100 can transform the AR console environment 102 into an augmented reality in which the user 118 can interact with the system 100.

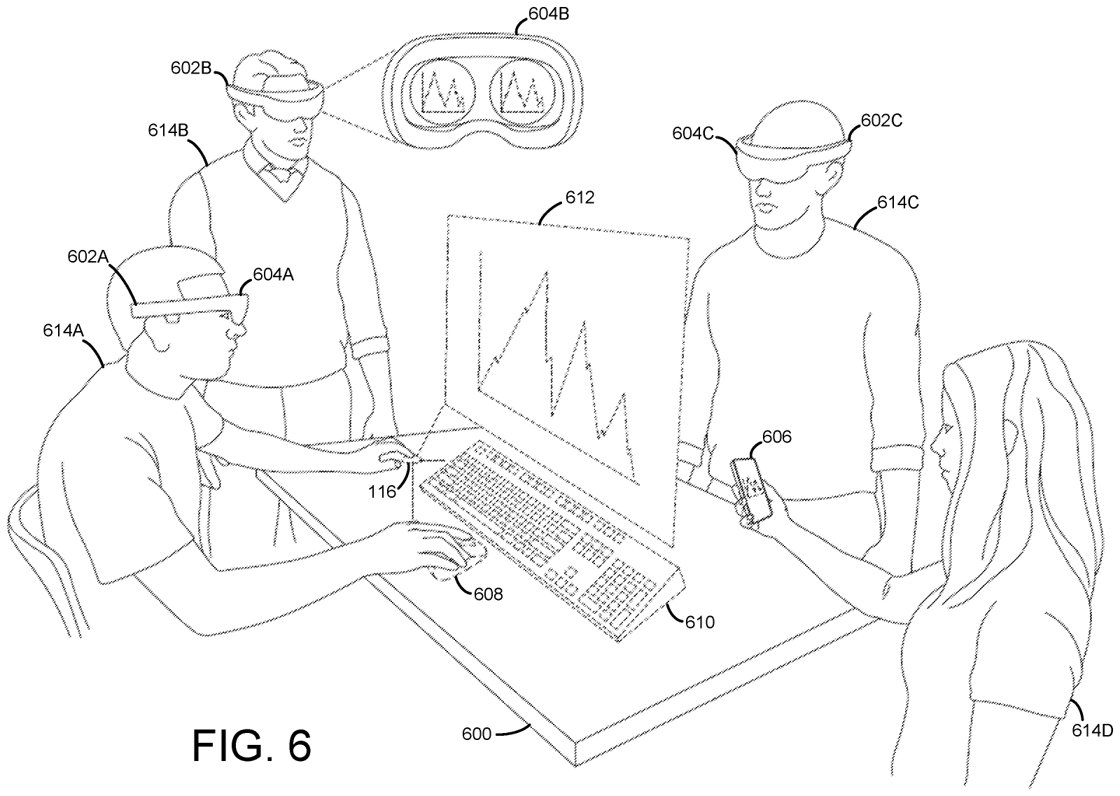

In some examples, the user interface controls that constitute the AR console 110 include anchor points (e.g., the anchor point 116), input devices controls (e.g., a virtual mouse or a virtual keyboard), output devices controls (e.g., a virtual monitor), combination input and output device controls (e.g., a virtual touchscreen or a gesture space), and the like. FIG. 6 illustrates portions of the AR console environment 102, including several examples of user interface controls that the clients 112 are configured to provide.

More specifically, FIG. 6 illustrates one example of an AR console environment 102 in which a group of users 614A-614D (e.g., the users 118 of FIG. 1) are collaborating via an AR console system (e.g., the AR console system 100 of FIG. 1) during execution of AR computing session. As shown in FIG. 6, each of the users 614A-614C is wearing a respective headset 602A-602C. Examples of AR headsets, such as the AR headsets 602A-602C include smartglasses such as the MIRCOSOFT HoloLens and the GOOGLE glass. The AR headsets 602A-602C include respective visors 604A-604C, depth cameras, microphones, network interfaces, and processors. The user 614D holds a smart phone 606 that includes a touchscreen, a camera, microphone, a network interface, and a processor. Each of the headsets 602A-602C and the smart phone 606 hosts an AR client (e.g., the client 112 of FIG. 1). FIG. 6 further illustrates user interface controls that constitute the AR console and that the AR clients are configured to provide. As shown, these user interface controls include the anchor point 116, the virtual mouse 608, the virtual keyboard 610, and the virtual monitor 612.

In FIG. 6, the user 118A selects the anchor point 116 by touching a physical location on the table 600 associated with the anchor point 116. This location may lie within, for example, a bounded physical area associated with the anchor point 116, such as a geometric figure (e.g., a circle, square, hexagon, etc.) covering a defined area of the table 600, or a point covering a nominal area. In this example, the AR client hosted by the headset 602A is configured to control the visor 604A to project the anchor point 116 into the user's 614A field of vision. This AR client is also configured to detect the touching of the location corresponding to the anchor point 116 by processing depth data generated by the depth camera included in the headset 602A.

As further illustrated in FIG. 6, the AR client hosted by the headset 602A is configured to, in response to detection of the user 614A touching the location associated with the anchor point 116, render the AR console including the virtual mouse 608, the virtual keyboard 610, and the virtual monitor 612. In some examples, the system 100 is configured to make at least some of the user interface controls of the AR console visible to the users 614B-614D via the AR clients hosted by their associated devices. For instance, as shown in FIG. 6, the AR client hosted by the headset 602B is configured to render the virtual monitor 612 visible to the user 614B via the visor 604B. Similarly, the AR client hosted by the smart phone 606 is configured to render the virtual monitor 612 visible to the user 614D via the touchscreen of the smart phone 606.

As shown in FIG. 6, the AR client hosted by the headset 602A is configured to track and respond to the user's 614A movements vis-à-vis the virtual mouse 608 and the virtual keyboard 610. More specially, in some examples, this AR client can be configured to track movement and clicks of the virtual mouse 608 and keystrokes on the virtual keyboard 610; to re-render the virtual mouse 608 and the virtual keyboard according to the tracked movement, clicks, and keystrokes; and to translate the movement, clicks, and keystrokes into input for one or more virtual machines (e.g., the virtual machine 109 of FIG. 1). In these examples, the AR client can also be configured to interoperate with the one or more virtual machines to process the input and provide output via the virtual monitor 612. For instance, the AR client can be configured to exchange (transmit and/or receive) messages with the one or more virtual machines that comply with the independent computing architecture (ICA) protocol and/or the remote desktop protocol (RDP). The AR client can be configured to transmit, via the messages, the input to the one or more virtual machines and to receive, via the messages, output from the one or more virtual machines resulting from processing of the input. The AR client can also be configured to render the output in the virtual monitor 612. In this way, the AR client hosted by the headset 602A enables the user 614A to conduct an AR computing session in which various information is displayed via the virtual monitor 612 by interacting with the virtual mouse 608 and the virtual keyboard 610.

In some examples, the AR clients hosted by the smart phone 606 and the headsets 602B and 602C are configured to render visible to the users 614B-614D only the content displayed on the virtual monitor 612. Thus, in these examples, the AR clients are configured to omit the anchor point 116, the virtual mouse 608, and the virtual keyboard from their associated visors and touchscreen. By rendering the anchor point 116 only via the AR client hosted by the headset 602A, these examples of the AR console system 100 provide additional security to the system 100 by requiring that the user 614A who placed the anchor point be the user who activates the anchor point. In other examples, the AR clients hosted by the smart phone 606 and the headsets 602B and 602C are configured to provide different content to each of the users 614B-614D based on configurable parameters stored within their associated devices. For example, the headset 602B can store a value of a configurable parameter that causes the hosted AR client to render textual content within the virtual monitor 612 in English while the smart phone 606 can store a value of a configurable parameter that causes the hosted AR client to render textual content within the virtual monitor 612 in Spanish. In another example, the headset 602C can store a value of a configurable parameter (e.g., that specifies an organization role or authority of the user 614C), that causes the hosted AR client to render only a portion, or none of, the content rendered to the other users 614A, 614B, and 614D.

In some examples, the AR clients hosted by the devices in FIG. 6 are configured to render the virtual monitor 612 as a virtual touchscreen. In these examples, the user 614A can conduct the AR computing session by manipulating the virtual monitor 612 as a touchscreen, rather than by interacting with the virtual mouse 608 and/or the virtual keyboard 610. Further, in some examples, the AR clients are configured to receive input from the users 614B-614D via the virtual monitor 612 as a touchscreen (or the virtual mouse 608 and/or the virtual keyboard 610). In still other examples, the hosted AR clients are configured to provide each of the users 614B-614D with user interface controls (such as a virtual mouse or keyboard) that enable them to particulate directly in the AR computing session and thereby manipulate the content displayed in the virtual monitor 612.

Although the AR console illustrated in FIG. 6 includes the virtual mouse 608, the virtual keyboard 610, and the virtual monitor 612, AR consoles, as described herein, are not limited to this configuration of virtual devices. For instance, in some examples, the AR console consists only of the virtual monitor 612. In these examples, the user 614A interacts with the AR console via a gesturing based interface, verbally, and/or a combination of gestures and audio input. In other examples, the AR console includes a plurality of virtual monitors.

Additionally, in some examples, the AR console may include a combination of virtual devices and physical devices. For instance, in some AR consoles, the virtual mouse 608 and/or virtual keyboard 610 can be replaced with a physical mouse and/or a physical keyboard. In these examples, the physical mouse and keyboard can communicate with devices that host AR clients via wired and/or wireless technologies, and the AR clients can process input provided by these physical devices using processes similar to those that process input received via virtual devices.

Returning to FIG. 1, in some examples, the user interface controls that each of the clients 112 is configured to provide includes a join control configured to receive user requests to join an AR computing session facilitated by the AR console 110. In these examples, each of the clients 112 is configured to receive selections of the join control and respond to the selections by identifying a location of a device hosting the client 112, accessing a map of an environment associated with and potentially including the location (i.e., a map of the AR console environment 102), and rendering the AR console 110 for the user 118 of the client 112 (as described above with reference to FIG. 6).

In some examples, each of the clients 112 is configured to interoperate with other devices to identify the host device's location relative to the other devices, such as global positioning satellites, Wi-Fi routers, locations beacons, and the like. These relative locations can be expressed as, for example, global positioning system coordinates, Wi-Fi service set identifiers, identifiers of one or more of the location beacons 114, and/or information derived from these sources. In at least one example, where the number of location beacons is 3 or more, each of the clients 112 is configured to determine strengths of signals received by the host device from each of the location beacons. Further, in this example, each of the clients 112 is configured to calculate a precise location of the host device by a triangulation process using recorded locations of the location beacons and the determined signal strengths.

In certain examples, to access a map of the AR console environment 102, each of the clients 112 is configured to attempt to download previously generated map data descriptive of the AR console environment 102 by interoperating with the AR console service 104. More specifically, in these examples, each of the clients 112 is configured to transmit a message to the AR console service 104 requesting download of map data descriptive of the environment of the host device. This message can include, for example, any of the location identifiers described above. To process responses that include requested map data, each of the clients 112 is configured to parse the responses and load the map data identified in the responses.

In some examples, where no map data is included in a response from the AR console service (e.g., no map data exists for an AR console environment 102), the map data can be generated on on-the-fly by the clients 112. In these examples, each of the clients 112 is configured to track the location of its host device and utilize sensors accessible by the host device to generate and/or update map data. For instance, in examples where the host device includes one or more local landmark detectors (e.g., a depth camera, sonar sensor, or the like) and/or one or more inertial measurement units (e.g., an accelerometer, gyroscope, magnetometer, or the like), the client 112A can be configured to execute a simultaneous localization and mapping (SLAM) process to generate and/or update map data for the AR console environment 102.

For instance, in some examples, the client 112A can scan the AR console environment 102 using the one or more landmark detectors to identify one or more landmarks. These landmarks can serve as reference points within a localized map and can include, for example, features of a room, such as doors, furniture, walls, wall joints, and other stationary objects/visual features. Further, in these examples, as the host device moves about the AR console environment 102, the client 112A can track its approximate location vis-à-vis the landmarks using, for example, odometry data from the one or more inertial measurement units and can periodically re-scan its local environment to re-identify landmarks, add new landmarks, and remove incorrectly identified landmarks. The client 112A can use the various instances of landmark and odometry data described above to generate and/or update map data. For instance, the client 112A can implement a Kalman filter that maintains and refines the map data by iteratively predicting the location of the host device (e.g., via the odometry data) and correcting its prediction (e.g., via the landmark data). Each of the clients 112 can also be configured to transmit the map data and/or updates of the map data to the AR console service 104 for storage and subsequent reuse.

In certain examples, the map data stores and identifies the three-dimensional location of previously established user interface controls within the mapped space of the AR console environment 102. The map data enables each of the clients 112 to accurately render user interface controls at target positions within the AR console environment 102 as viewed via a user interface (e.g., as viewed via a visor or a touchscreen). The map data can include a depth map of the AR console environment 102. The map data can be encoded according to a variety of formats. For instance, in at least one example, the depth map is encoded as a monochrome portable network graphics file. In these examples, each of the clients 112 can be configured to restore the previously established user interface controls for its user 118 by projecting and/or displaying the user interface controls at the target positions as presented via the visors and/or touchscreens.

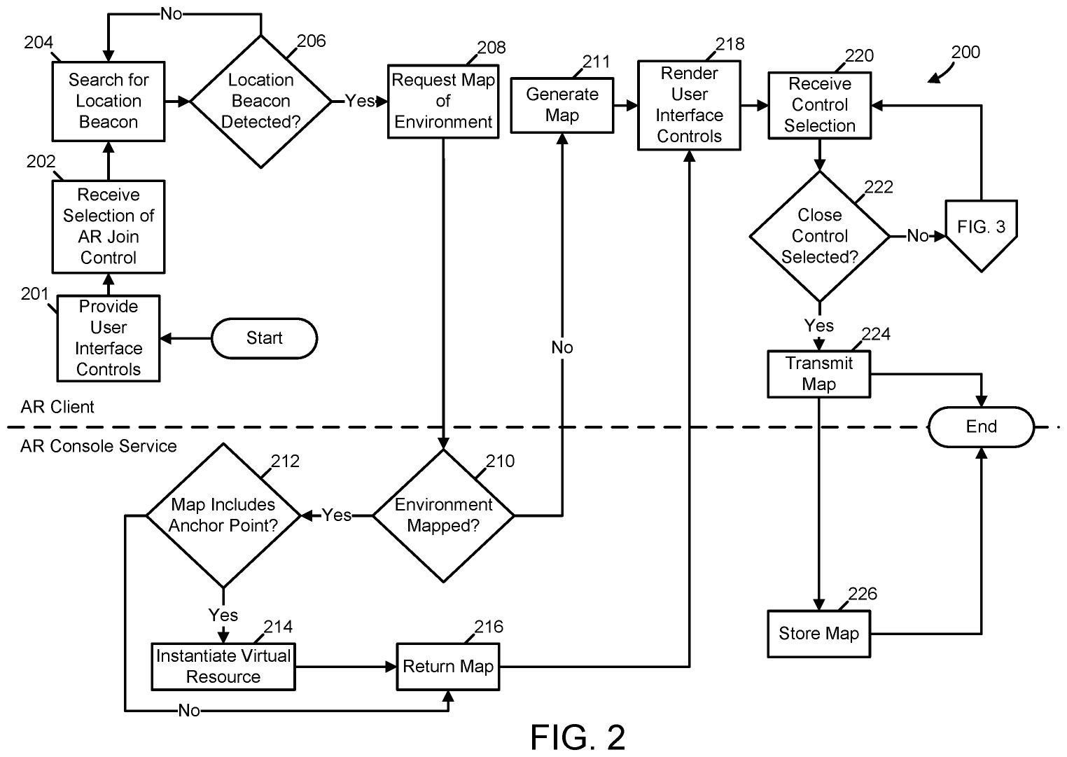

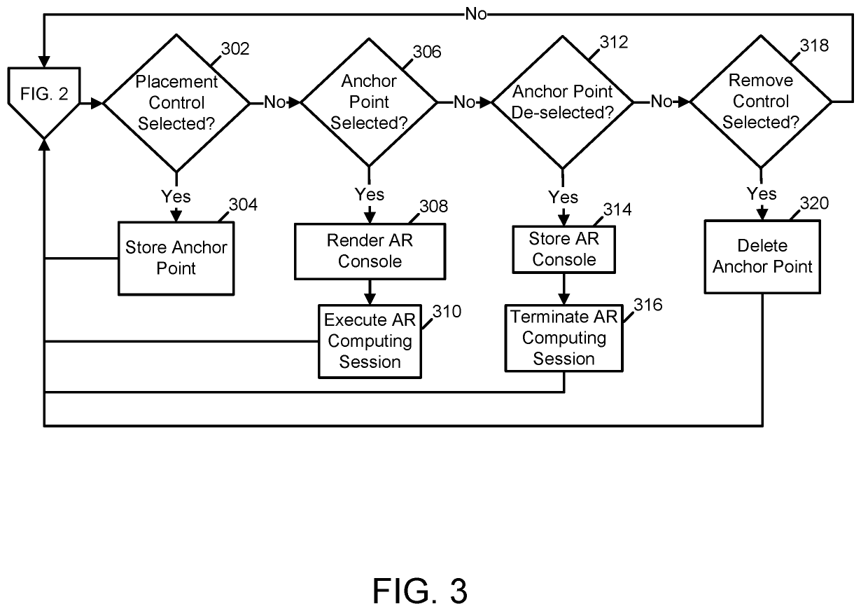

In certain examples, each of the clients 112 is configured to enable its associated user 118 to participate in an interactive AR computing session. In these examples, each of the clients 112 is configured to interoperate with the virtual machine 109 by transmitting input acquired from the users 118 via the AR console 110. The virtual machine 109 is configured to process this input and to transmit output resulting from the processing to the clients 112. Each of the clients 112, in turn, is configured to again interoperate with the virtual machine 109 by receiving the output and rendering it via the AR console 110. Alternatively, the clients 112 can be configured to execute the AR computing session themselves where the clients 112 collectively have sufficient resources to do so. These and other processes that the AR clients of FIGS. 1 and 6 are configured to execute in conjunction with the other components of the system 100 are described further below with reference to FIGS. 2 and 3.

In some examples, the console service 104 is configured to implement a set of platform features that support the clients 112 during initiation and termination of AR computing sessions. This set of features can include map-related features (e.g., storing/retrieving localized maps including anchor points, etc.) and session initialization features. As illustrated in FIG. 1, the console service 104 is configured to implement this feature set by executing a variety of processes, including processes that involve communications with the clients 112, the data store 106, and the hypervisor 108.

In some examples, the AR console data store 106 includes data structures configured to store map data, interface control information, and anchor point information. The map data can include, for example, a record for each mapped AR environment (e.g., the AR environment 102). Each of these map data records can include a field configured to store a depth map of the AR environment associated with the record. The map data records can also include a field configured to store an identifier of the AR environment (e.g. a location identifier of the AR environment).

In certain examples, the interface control information can include a record for each user interface control established and stored via the clients 112. Each of these interface control records can include a field configured to store an identifier of the user interface control. Each of the interface control records can also include a field configured to store an identifier of the AR environment in which the user control was established and stored. Each of the interface control records can also include a field configure to store a target location (e.g., one or more identifiers of depth map pixels) within the depth map of the AR environment that correspond to a physical position in the AR environment at which the user control is to be rendered. Each of the interface control records can also include a field configured to store an identifier of the user interface control type (e.g., the anchor point 116, any of the virtual devices described above with reference to FIG. 6, etc.).

In some examples, the anchor point information can include a record for each anchor point established and stored via the client 112. Each of these anchor point records can include a field configured to store an identifier of an anchor point (e.g., the same identifier used to identify the anchor point in the interface control information). Each of the anchor point records can also include a field configured to store an identifier of a specification of virtual resources needed to implement an AR console associated with the anchor point (e.g., an identifier of a virtual desktop or virtual application). Each of the anchor point records can also include a field configured to store an identifier of a user who placed the anchor point in an AR environment. Each of the anchor point records can also include a field configured to store a duration of time after which the anchor point is no longer available for selection. Each of the anchor point records can also include one or more fields configured to one or more identifiers of user interface controls, such as those that constitute an AR console, that are associated with the anchor point and to be rendered upon selection of the anchor point. In some examples, the interface control information and the anchor point information are included in the map data. The data store 106 can be implemented using a variety of data storage technology, such as relational and non-relational databases, operating system files, hierarchical databases, or the like.

In some examples, the console service 104 is configured to communicate with the clients 112, the data store 106, and the hypervisor 108 by exchanging (i.e., transmitting and/or receiving) messages via one or more system interfaces (e.g., a web service application program interface (API), a web server interface, fibre channel interface, etc.). For instance, in some examples, one or more server processes included within the console service 104 exchange messages with various types of client processes via the systems interfaces. These client processes can include the hypervisor 108 and/or the clients 112.

In certain examples, the messages exchanged between the console service 104 and a client process can include requests to upload and store, retrieve and download, and/or synchronize maps of AR console environments (e.g., the AR console environment 102). In these examples, requests involving upload, download, and synchronization of map data can include an identifier of the map and/or map data representative of a three-dimensional space that is the subject of the map. The identifier of the map can include, for example, global positioning system coordinates, Wi-Fi service set identifier, identifiers of one or more of the location beacons 114, and/or information derived from these sources.

In some examples, the console service 104 is configured to respond to a request to upload and store map data by receiving the map data and storing the map data in the AR console data store 106. The console service 104 can also be configured to respond to a request to synchronize map data by receiving updates to the map data, identifying related map data in the AR console data store 106, and updating the related map data with the received map data. The console service 104 can further be configured to respond to a request to download map data by searching the AR console data store 106 for map data associated with a location specified in the request, retrieving any map data returned from the search, and transmitting a response including the returned map data, or an indication that no map data was found, to the requesting process.

In some examples, the messages exchanged between the console service 104 and a client process can include requests to initiate an AR computing session. In these examples, such requests can include an identifier of a request application or a virtual computing platform. In these examples, the console service 104 can configured to respond to a request to initiate an AR computing session by interoperating with the hypervisor 108 to initiate a virtual application, desktop, or other virtualized resource identified in the request to initiate the AR computing session. For instance, the hypervisor 108 can instantiate the virtual machine 109. Further, in these examples, the console service 104 can be configured to transmit a response to the requesting process that includes an identifier (e.g., a transmission control protocol/internet protocol address, etc.) of the virtualized resource. These and other processes that the console service 104 of FIG. 1 is configured to execute in conjunction with the other components of the system 100 are described further below with reference to FIGS. 2 and 3.

### AR Console Processes

As described above, some examples of the system 100 of FIG. 1 are configured to execute AR processes that provision AR consoles and execute AR computing sessions. FIGS. 2 and 3 illustrate an example of AR process 200 executed by the system 100 in some examples.

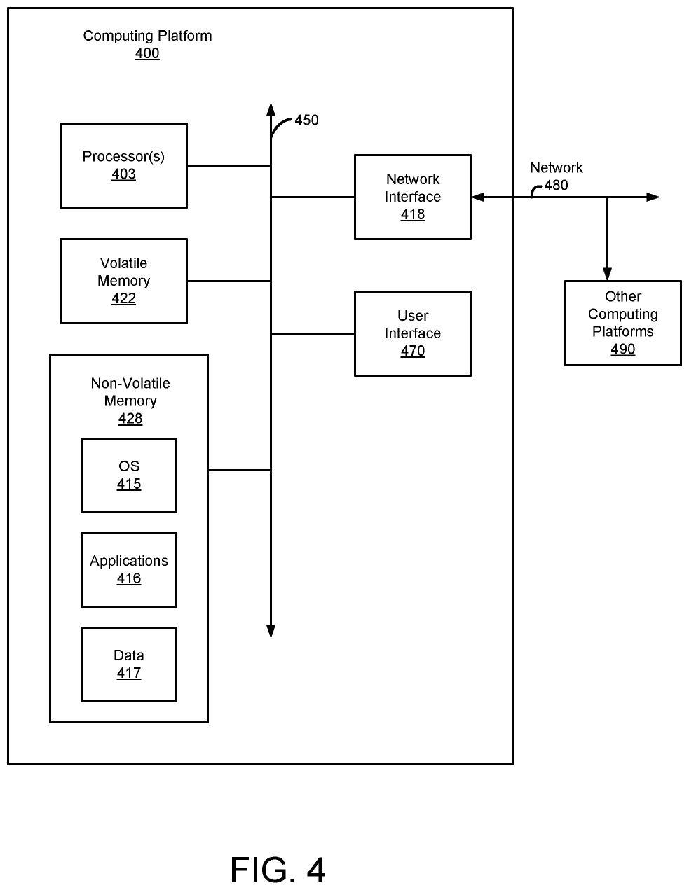

The process 200 starts with a computing device (e.g., the AR headset 602A, the smart phone 606, or some other computing platform as described below with reference to FIG. 4) hosting an AR client (e.g., the AR client 112 of FIG. 1) providing 201 a user interface controls to a user (e.g., the user 118). For instance, where the computing device is an AR headset, the AR client can provide 201 the user interface controls by projecting the user interface controls onto a visor integral to the AR headset. Alternatively or additionally, where the computing device is a smart phone, the AR client can provide 201 the user interface controls by rendering the user interface controls within a touchscreen (or display screen) integral to the smart phone. The user interface controls can include a variety of controls including an AR join control that can be selected by the user to request that an AR computing session be established with her current environment.

Continuing the process 200, the AR client receives 202 a selection of the AR join control. In response to reception of the AR join control, the AR client attempts to identify the location of the computing device by searching 204 for one or more location beacons (e.g., BLUETOOTH low energy beacons). Next, the AR client determines whether a beacon is detected 206. Where the AR client does not detect 206 a beacon, the AR client returns to searching 204. Where the AR client detects 206 a beacon, the AR client responds by requesting 208 a map of the current environment of the computing device. For instance, in one example, the AR client transmits a request including an identifier of the location beacon to an AR console service (e.g., the AR console service 104 of FIG. 1).

Continuing the process 200, the AR console service determines 210 whether a map of the current environment of the computing device is available. For instance, in some examples, the AR console service searches an AR console data store (e.g., the AR console data store 106 of FIG. 1) for a record that includes the identifier of the location beacon. Where the AR console service determines 210 that a map of the current environment of the computing device is not available (e.g., the search of the AR console data store yields no results), the AR console service transmits a response to the AR client indicating that no map data is available for the current environment of the computing device.

Where the AR console service determines 210 that a map of the current environment of the computing device is available (e.g., the search of the AR console data yields a result), the AR console service determines 212, whether map data defining the map includes one or more anchor points. Where the AR console service determines 212 that the map data does not include any anchor points, the AR console service returns 216 the map to the AR client by transmitting a response to the AR client including the map data or a link to the map data.

Where the AR console service determines 212 that the map data includes one or more anchor points, the AR console service identifies, within the AR console data store, any virtual resources needed to support the AR console associated with the anchor point and initiates 214 the virtual resources. For instance, where the anchor point is associated with a virtual spreadsheet application, the AR console service transmits a request to a hypervisor (e.g., the hypervisor 108 of FIG. 1) to instantiate the virtual spreadsheet application within a virtual machine (e.g., the virtual machine 109) in preparation of receiving a selection of the anchor point. Thus, in some examples, the AR console service leverages the anchor point information to proactively initiate virtual resources, thereby decreasing any latency experienced by users at the onset of an AR computing session. Next, the AR console service returns 216 the map to the AR client by transmitting a response to the AR client including the map data or a link to the map data.

Where the AR client receives a response from the AR console service that indicates no map of the current environment of the computing device is available, the AR client generates 211 a map of the current environment of the computing device. For instance, the AR client can generate map data by executing a SLAM process using landmark detectors and/or inertial measurement units integral to or accessible by the computing device.

Where the AR client receives a response from the AR console service that indicates that a map of the current environment is available (or where the AR client generates 211 enough map data to detect a surface at the current environment), the AR client renders 218 user interface controls based on the map data. The user interface controls can include a variety of controls, such as a close session control, an anchor point placement control, an anchor point removal control, and anchor points defined in the current environment. Some of the controls (e.g., anchor points) can be overlaid upon physical objects in the current environment. Other controls (the session close control, the anchor point placement control, and/or the anchor point removal control), can be rendered at a fixed location within the user interface (e.g., at a fixed location within a visor, physical touchscreen, etc.) or may not be rendered visually. Controls without a visual representation can be selected by the user via audio or gestural input.

Next, the AR client receives 220 a selection of a user interface control. For example, the AR client can receive a message from an operating system of the computing device that includes input specifying that the control is selected by the user. In response to reception of the selection of the control, the AR client determines 222 whether the close control is selected. Where the close control is selected, the AR client transmits 224 any map data of the current environment not previously transmitted to the AR console service, transmits a shutdown request to any virtual resources involved in the AR computing session, removes the user interface controls, and terminates its participation in the process 200.

Where the AR console service receives map data from the AR client, the AR console service stores 226 the received map data in the AR console data store and terminates its participation in the process 200. It should be noted that the received map data can include data descriptive of the physical layout of, and physical objects in, the current environment and target locations of one or more user interface controls (e.g., anchor points and/or virtual devices) that define target positions of the one or more user interface controls within the current environment.

With reference to FIG. 3, where the close control is not selected, the AR client determines 302 whether a control to place an anchor point is selected. Where the AR client determines 302 that such a placement control is selected, the AR client stores 304 a user-selected location for the anchor point in the map data and creates anchor point information. This anchor point information can identify the user who placed the anchor point, specify a default duration during which the anchor point will remain available for selection, and specify a default configuration of virtual resources to support an AR computing session associated with the anchor point. This default configuration can include virtual resources to be made available during the AR computing session. In some examples, the AR client prompts the user, via user interface controls, with the default values and receives modifications to the default values from input provided by the user to the user interface controls.

Where the AR client determines 302 that a placement control is not selected, the AR client determines 306 whether an anchor point is selected. Where the AR client determines 306 that an anchor point is selected, the AR client renders 308 an AR console (e.g., the AR console 110 of FIG. 1) and executes 310 an AR computing session. Where the AR console previously instantiated the virtual resources (e.g., the virtual machine 109 of FIG. 1) for the AR computing session, the AR client leverages those resources. Where the AR console did not previously instantiate the virtual resources (e.g., no anchor point where present in map data for the current environment), the AR client transmits a message to the hypervisor to request the virtual resources. Executing 310 an AR computing session can include numerous interactions between the user (or other users 118 of FIG. 1) and the AR console. These interactions can include, for example, establishing and storing additional user interface controls within the AR environment and utilizing established user interface controls to drive processing performed by the virtual resources supporting and implementing the AR computing session. Execution 310 of the AR computing session terminates where the user who selected the anchor point, de-selects the anchor point.

Where the AR client determines 306 that an anchor point is not selected, the AR client determines 312 whether an anchor point is de-selected. Where the AR client determines 312 that an anchor point is de-selected, the AR client stores 314 specifications descriptive of the virtual resources used to execute the AR computing session as anchor point information within the map data, terminates 316 the rendering of the AR console, and instructs the virtual resources to shut down.

Where the AR client determines 312 that an anchor point is not de-selected, the AR client determines 318 whether a control to remove an anchor point is selected. Where the AR client determines 318 that such a remove control is selected, the AR client deletes 320 a location for the selected anchor point from the map data and deletes its associated anchor point information.

Process in accordance with the process 200 enable the system 100 to execute AR computing sessions via an AR console, as described herein.

The process 200 as disclosed herein depicts one particular sequence of acts in a particular example. Some acts are optional and, as such, can be omitted in accord with one or more examples. Additionally, the order of acts can be altered, or other acts can be added, without departing from the scope of the apparatus and methods discussed herein. For instance, in at least one example, the process 200 starts with searching 204 for location beacons and does not depend upon providing 201 or receiving 202 as initial actions.

### Computing Platform for AR Console Systems

FIG. 4 is a block diagram of a computing platform 400 configured to implement various AR console systems and processes in accordance with examples disclosed herein.

The computing platform 400 includes one or more processor(s) 403, volatile memory 422 (e.g., random access memory (RAM)), non-volatile memory 428, a user interface (UI) 470, one or more network or communication interfaces 418, and a communications bus 450. The computing platform 400 may also be referred to as a computer or a computer system.

The non-volatile (non-transitory) memory 428 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 470 can include a graphical user interface (GUI) (e.g., controls presented on a touchscreen, a display, visor, etc.) and one or more input/output (I/O) devices (e.g., a mouse, a keyboard, a microphone, one or more speakers, one or more cameras, one or more biometric scanners, one or more environmental sensors, and one or more accelerometers, one or more visors, etc.).

The non-volatile memory 428 stores an operating system 415, one or more applications or programs 416, and data 417. The operating system 415 and the application 416 include sequences of instructions that are encoded for execution by processor(s) 403. Execution of these instructions results in manipulated data. Prior to their execution, the instructions can be copied to the volatile memory 422. In some examples, the volatile memory 422 can include one or more types of RAM and/or a cache memory that can offer a faster response time than a main memory. Data can be entered through the user interface 470 or received from the other I/O device(s), such as the network interface 418. The various elements of the platform 400 described above can communicate with one another via the communications bus 450.

The illustrated computing platform 400 is shown merely as an example client device or server and can be implemented within any computing or processing environment with any type of physical or virtual machine or set of physical and virtual machines that can have suitable hardware and/or software capable of operating as described herein.

The processor(s) 403 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 403 can be analog, digital or mixed. In some examples, the processor 403 can be one or more physical processors, or one or more virtual (e.g., remotely located or cloud) processors. A processor including multiple processor cores and/or multiple processors can provide functionality for parallel, simultaneous execution of instructions or for parallel, simultaneous execution of one instruction on more than one piece of data.

The network interfaces 418 can include one or more interfaces to enable the computing platform 400 to access a computer network 480 such as a Local Area Network (LAN), a Wide Area Network (WAN), a Personal Area Network (PAN), or the Internet through a variety of wired and/or wireless connections, including cellular connections and BLUETOOTH connections. In some examples, the network 480 may allow for communication with other computing platforms 490, to enable distributed computing.

In described examples, the computing platform 400 can execute an application on behalf of a user of a client device. For example, the computing platform 400 can execute one or more virtual machines managed by a hypervisor. Each virtual machine can provide an execution session within which applications execute on behalf of a user or a client device, such as a hosted desktop session. The computing platform 400 can also execute a terminal services session to provide a hosted desktop environment. The computing platform 400 can provide access to a remote computing environment including one or more applications, one or more desktop applications, and one or more desktop sessions in which one or more applications can execute.

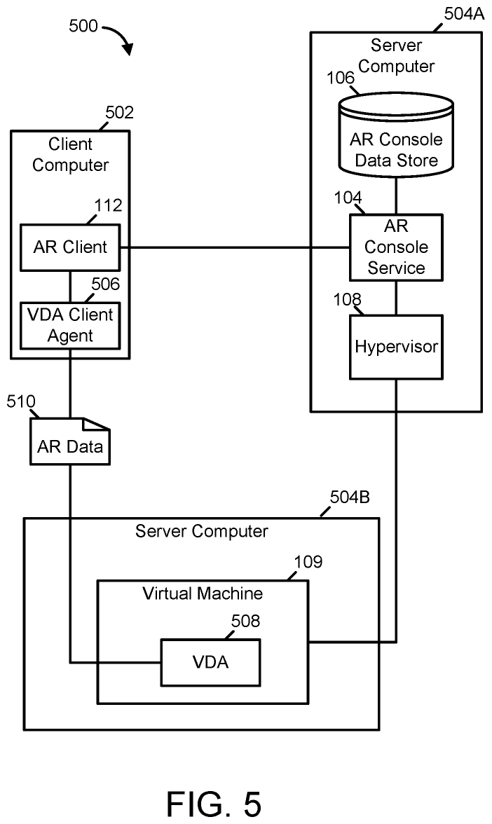

FIG. 5 illustrates an AR console system (e.g., the system 100 of FIG. 1) configured for operation within a distributed computing platform (e.g. the computing platform 400 of FIG. 4). As shown in FIG. 5, the configuration 500 includes a client computer 502 and server computers 504A and 504B. Within the configuration 500, the computer systems 502, 504A, and 504B are communicatively coupled to one another and exchange data via a network.

As illustrated in FIG. 5, the client computer 502 is configured to host the AR client 112 of FIG. 1. Examples of the client computer 502 include the AR headsets 602A-602C and the smart phone 606 of FIG. 6. The server computer 504A is configured to host the AR console service 104, the AR console data store 106, and the hypervisor 108 of FIG. 1. The server computer 504B is configured to host the virtual machine 109. Examples of the server computers 504A and 504B include the computing platform 400 of FIG. 4. Many of the components illustrated in FIG. 5 are described above with reference to FIGS. 1, 4, and 6. For purposes of brevity, those descriptions will not be repeated here, but each of these components is configured to function with reference to FIG. 5 as described with reference to its respective figure. However, the descriptions of any of these components may be augmented or refined below.

As shown in FIG. 5, the AR client 112 is configured to provide user access to an AR computing session via an AR console (e.g., the AR console 110 of FIG. 1). To implement the AR computing session and console, the AR client 112 is configured to exchange input and output AR data 510 with the virtual machine 109. The virtual deliver agent (VDA) 508 and the VDA client agent 506 are configured to interoperate to support this exchange of the AR data 510.

The configuration 500 is but one example of many potential configurations that can be used to implement the system 100. As such, the examples disclosed herein are not limited to the particular configuration 500 and other configurations are considered to fall within the scope of this disclosure.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

1. A computer system comprising:
a memory;
a network interface;
a user interface; and
at least one processor coupled to the memory, the network interface, and the user interface and configured to
detect a location identifier via the network interface;
identify map data associated with the location identifier, the map data being descriptive of a physical environment;
identify at least one target location in the map data, the at least one target location being associated with an augmented reality (AR) console including one or more user interface controls, the at least one target location identifying at least one target position within the physical environment; and
overlay the at least one target position, as presented via the user interface, with the AR console.

2. The computer system of claim 1, wherein the location identifier is one or more of a set of global positioning system coordinates, a network service set identifier, and a location beacon identifier.

3. The computer system of claim 1, wherein to detect the location identifier comprises to detect one or more location beacons.

4. The computer system of claim 3, wherein to detect the one or more location beacons comprises to detect at least three location beacons and to detect the location identifier comprises to triangulate a location from the at least three location beacons.

5. The computer system of claim 1, further comprising a remote AR console service, wherein to identify the map data comprises to:
transmit the location identifier to the remote AR console service; and
receive the map data from the remote AR console service.

6. The computer system of claim 1, wherein to identify the map data comprises to:
determine that no previously generated map data descriptive of the physical environment is accessible; and
execute a simultaneous localization and mapping process to generate the map data.

7. The computer system of claim 6, wherein the at least one processor is further configured to upload the map data to the remote AR console service.

8. The computer system of claim 1, wherein the at least one processor is further configured to:
identify an anchor point having a target location in the map data, the target location identifying a target position within the physical environment; and
overlay the target position, as presented via the user interface, with the anchor point,
wherein to identify the at least one target location comprises to
receive a selection of the anchor point,
identify the one or more user interface controls as being associated with the anchor point, and
identify the at least one target location as being associated with the one or more user interface controls.

9. The computer system of claim 1, wherein the one or more user interface controls comprise two or more virtual monitor controls.

10. The computer system of claim 1, wherein the at least one processor is further configured to:
receive input via the AR console;
transmit the input to a virtual resource;
receive output from the virtual resource; and
render the output within the AR console.

11. The computer system of claim 1, wherein the location identifier is a first location identifier, the map data is first map data, the physical environment is a first physical environment, the at least one target location is at least one first target location, the AR console is a first AR console, the target position is a first target position, and the at least one processor is further configured to:
detect a second location identifier via the network interface;
identify second map data associated with the second location identifier, the second map data being descriptive of a second physical environment;
identify at least one second target location in the second map data associated with a second AR console, the at least one second target location identifying at least one second target position within the second physical environment; and
overlay the at least one second target position, as presented via the user interface, with the second AR console.

12. A method of providing at least one augmented reality (AR) console using a computer system comprising a network interface and a user interface, the method comprising:
detecting a location identifier via the network interface;
identifying map data associated with the location identifier, the map data being descriptive of a physical environment;
identifying at least one target location in the map data, the at least one target location being associated with an AR console including one or more user interface controls, the at least one target location identifying at least one target position within the physical environment; and
overlaying the at least one target position, as presented via the user interface, with the AR console.

13. The method of claim 12, wherein detecting the location identifier comprises detecting one or more location beacons.

14. The method of claim 13, wherein detecting the one or more location beacons comprises detecting at least three location beacons and detecting the location identifier comprises triangulating a location from the at least three location beacons.

15. The method of claim 12, wherein identifying the map data comprises:
determining that no previously generated map data descriptive of the physical environment is accessible; and
executing a simultaneous localization and mapping process to generate the map data.

16. The method of claim 15, further comprising uploading the map data to a remote AR console service.

17. The method of claim 12, further comprising:
identifying an anchor point having a target location in the map data; and
overlaying the target location, as presented via the user interface, with the anchor point,
wherein identifying the at least one target location comprises
receiving a selection of the anchor point,
identifying the one or more user interface controls as being associated with the anchor point, and
identifying the at least one target location as being associated with the one or more user interface controls.

18. The method of claim 12, wherein identifying the at least one target location comprises identifying two or more target locations associated with two or more virtual monitor controls.

19. The method of claim 12, further comprising:
receiving input via the AR console;
transmitting the input to a virtual resource;
receiving output from the virtual resource; and
rendering the output within the AR console.

20. The method of claim 12, wherein the location identifier is a first location identifier, the map data is first map data, the physical environment is a first physical environment, the at least one target location is at least one first target location, the AR console is a first AR console, the target position is a first target position, and the method further comprises:
detecting a second location identifier via the network interface;
identifying second map data associated with the second location identifier, the second map data being descriptive of a second physical environment;
identifying at least one second target location in the second map data associated with a second AR console, the at least one second target location identifying at least one second target position within the second physical environment; and
overlaying the at least one second target position, as presented via the user interface, with the second AR console.

21. A non-transitory computer readable medium storing processor executable instructions to provide at least one augmented reality (AR) console, the instructions comprising instructions to:
detect a location identifier via a network interface;
identify map data associated with the location identifier, the map data being descriptive of a physical environment;
identify at least one target location in the map data, the at least one target location being associated with an AR console including one or more user interface controls, the at least one target location identifying at least one target position within the physical environment; and
overlay the at least one target position, as presented via the user interface, with the AR console.

22. The computer readable medium of claim 21, wherein the instructions to identify the map data comprise instructions to:
determine that no previously generated map data descriptive of the physical environment is accessible; and
execute a simultaneous localization and mapping process to generate the map data.

23. The computer readable medium of claim 21, further comprising instructions to:
identify an anchor point having a target location in the map data; and
overlay the target location, as presented via the user interface, with the anchor point,
wherein the instructions to identify the at least one target location comprise instructions to
receive a selection of the anchor point,
identify the one or more user interface controls as being associated with the anchor point, and
identify the at least one target location as being associated with the one or more user interface controls.

24. The computer readable medium of claim 21, wherein the instructions to identify the at least one target location comprise instructions to identify two or more target locations associated with two or more virtual monitor controls.

25. The computer readable medium of claim 21, further comprising instructions to:
receive input via the AR console;
transmit the input to a virtual resource;
receive output from the virtual resource; and
render the output within the AR console.
